(19) United States
(12) Patent Application Publication
(10) Pub. No.: US 2022/0193969 A1
(43) Pub. Date: Jun. 23, 2022

(54) INJECTION MOLD COOLING TECHNIQUES

(71) Applicant: Instaversal MFG Corporation, Newton, MA (US)

(72) Inventors: Zakary Tyler Smith, La Jolla, CA (US); Mark Yam, Monte Sereno, CA (US); Sudarshan Bharat Shetty, Roxbury, MA (US); Andrew J. Hudak, IV, San Francisco, CA (US); Richard Warren Blossom, Tiburon, CA (US); Edward Fu, Sammamish, WA (US); YenChi Chang, Tarzana, CA (US)

(21) Appl. No.: 17/554,407

(22) Filed: Dec. 17, 2021

Related U.S. Application Data
(60) Provisional application No. 63/127,769, filed on Dec. 18, 2020.

(51) Int. Cl. B29C 45/78; B29C 45/73; B29C 45/14; G06F 30/20

(52) U.S. Cl. CPC B29C 45/78; B29C 45/73; B29C 45/14467; B29C 2945/76939; B29C 2945/7604; B29C 2945/76294; G06F 30/20

(57) ABSTRACT

An apparatus, system, and method of forming a mold insert for an injection molding operation, comprising: providing a design of an injection mold part; analyzing, by a predictive model, the design to determine a conformal cooling arrangement for a mold insert for forming the injection mold part; and forming the mold insert including the conformal cooling arrangement.

### RELATED APPLICATIONS

This application claims the benefit of and priority to U.S. provisional application No. 63/127,769, filed Dec. 18, 2020, titled “INJECTION MOLD COOLING TECHNIQUES,” the entirety of which is incorporated by reference herein.

### FIELD

The present invention relates generally to field of injection molding, and more specifically to systems and methods for cooling techniques for part production processes during a material injection molding operation.

### BACKGROUND

Insert injection molding processes typically include a preformed metal and/or plastic insert that is loaded into a mold base prior to an injection molding operation. A polymer material, e.g., a thermoplastic resin or thermoset with plastics, metals, and/or other materials, is molded or otherwise formed about the insert to create a final component. Mold inserts can be interchangeable to produce multiple parts having minor variations, or different parts.

Molded parts are generally formed at high temperatures. As high temperature liquid materials are injected into molds, they must undergo a solidification process prior to their ejection, which requires a majority of cycle time (up to 90%) for cooling the components. This in turn requires increased time and costs associated with producing injection-molded items. In addition, inadequate cooling of the molding during solidification may result in mold imperfections.

### SUMMARY

All examples and features mentioned below can be combined in any technically feasible way.

In one aspect, a method of forming a mold insert for an injection molding operation, comprises providing a design of an injection mold part; analyzing, by a predictive model, the design to determine a conformal cooling arrangement for a mold insert for forming the injection mold part; and forming the mold insert including the conformal cooling arrangement.

In another aspect, a method for molding a part of interest comprises providing a design of an injection mold part; analyzing, by a predictive model, the design to determine a conformal cooling arrangement for a mold insert for forming the injection mold part; forming the mold insert including the conformal cooling arrangement; and forming the injection mold part by heating a source of material at the mold insert and cooling the source of material by the conformal cooling arrangement.

One or more of the following embodiments pertain to a foregoing aspect.

The method may further comprise embedding a sensor in the injection mold insert for providing a feedback loop that modifies a result of the predictive model. The sensor may at least one of measure temperature as a function of time, measure pressure as a function of time, and identify an opening and closing of a mold.

Analyzing, by the predictive model, the design may include integrating CAD model data of a first CAD design of the design with a set of project-specific process parameters or other information; identifying, by the predictive model, potential improvements to the first CAD design to generate a second CAD design; comparing, by the predictive model, the first CAD design and the second CAD design to identify possible improvements to the second CAD design.

The predictive model may be analyzed by an artificial intelligence system to identify features pertaining to a design of conformal cooling lines of the conformal cooling arrangement within the mold insert.

The method may further comprise modifying the design so that the cooling flow geometry and direction from heat dissipation from hotspots detected in the part is changed to reduce or eliminate the hotspots. The hotspots may be digital representations of the injection mold part and are emulated in response to the step of analyzing, by a predictive model, the design.

The method may further comprise forming at least one lattice matrix into cooling channels of the conformal cooling arrangement.

The method may further comprise executing an artificial intelligence process to calculate data metrics in response to forming the injection mold part from the produced mold insert; and inputting the data metrics to the predictive model.

The method may further comprise performing a part selection process including determining a part volume to surface area ratio; and modifying the design of the injection mold part in response to the part volume to surface area ratio exceeding a predetermined threshold.

The method may further comprise performing a machine operation on the mold insert; collecting data on time savings estimates due to the conformal cooling arrangement; and generating a financial invoice from the collected data.

In another aspect, a part formed according to the process comprises steps of: providing a design of an injection mold part; analyzing, by a predictive model, the design to determine a conformal cooling arrangement for a mold insert for forming the injection mold part; forming the mold insert including the conformal cooling arrangement; and forming the injection mold part by heating a source of material at the mold insert and cooling the source of material by the conformal cooling arrangement.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of a system for performing an injection molding operation at which embodiments of the present inventive concepts can be practiced.

FIG. 2 is a flow diagram of a method for forming a mold insert for a part production process, in accordance with some embodiments.

FIG. 3 is a flow diagram of a part production process for injection molding, in accordance with some embodiments.

FIG. 4 is a flow diagram of a part selection process, in accordance with some embodiments.

FIG. 5 is a flow diagram of a part redesign and optimization process, in accordance with some embodiments.

FIG. 6 is a flow diagram of a business process executed by the system of FIG. 1, in accordance with some embodiments.

FIG. 7 is a flow diagram of a manufacturing process executed by the system of FIG. 1, in accordance with some embodiments.

FIG. 8A is a perspective view of a mold insert, in accordance with some embodiments.

FIG. 8B is a perspective view of the mold insert of FIG. 8A exposing an interior to further illustrate an arrangement of cooling lines, in accordance with some embodiments.

FIG. 8C is a cutaway front view of the mold insert of FIGS. 8A and 8B.

FIG. 8D is a perspective view of the mold insert of FIGS. 8A-8C, including a view of the interior of the mold insert to illustrate a plurality of holes in the mold insert in proximity to the arrangement of cooling lines

FIG. 9 is a view of a plastic molded part formed at least in part by the mold insert of FIGS. 8A and 8B.

FIGS. 10 and 11 are comparative displays of hot spots on a conventional plastic injection molded part and the plastic injection molded part of FIG. 9.

FIG. 12 is a graph illustrating comparative temperature results of a conventional plastic injection molded part and the plastic injection molded part of FIG. 9.

FIG. 13 is a perspective view of a lattice matrix of a mold insert, in accordance with some embodiments.

FIG. 14A is a perspective view of a dynamic cooling channel, in accordance with some embodiments.

FIG. 14B is another perspective view of a dynamic cooling channel of FIG. 14B.

FIG. 14C is another perspective view of a dynamic cooling channel of FIGS. 14A and 14B.

FIG. 14D is another view of the dynamic cooling channel of FIG. 14C, taken along lines 14D-14D.

### DESCRIPTION OF EMBODIMENTS

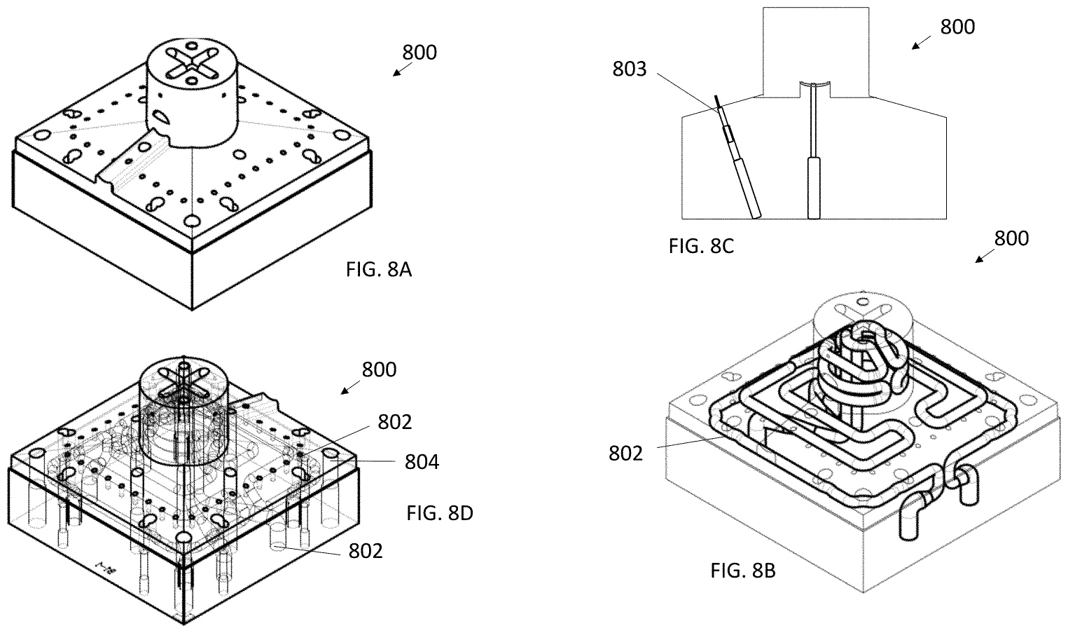

In brief overview, disclosed are embodiments of the present inventive concept including systems and methods for forming a three-dimensional (3D) metal printed mold insert for use in an insert injection molding process, in particular, for cooling molded objects of interest, also referred to as parts or items. As shown by way of example at FIGS. 8A-8D, 9, and 11, mold inserts may be used to produce parts for a wide range of applications and industries, such as medical, consumer, automotive, and so on. Implementations may be part of a Manufacturing as a Service (MaaS), but not limited thereto. Although the formation of mold inserts and molds include plastic and/or metal materials such as ceramics, polymers, and/or other material(s) that can change between liquid, gas, and solid states when exposed to a decrease in temperature. Preferably, the mold inserts are formed of metal and require a 3D metal printing apparatus or the like in doing so, and the parts are formed of polymers such as plastic and require the formed mold inserts in doing so.

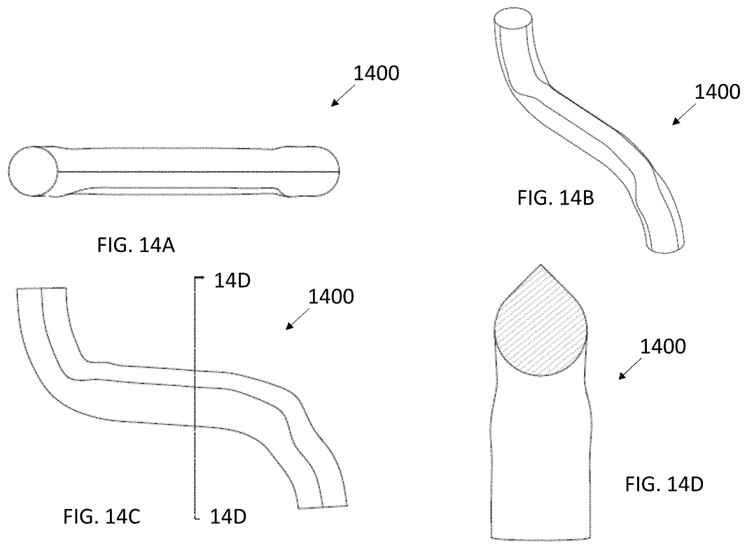

In some embodiments, prior to the design of a mold insert, proprietary predictive engineering models, also referred to as predictive models, are generated based on the geometry of the injection mold tool and part of interest to being molded. For example, predictive engineering models can be used to form a mold insert which in turn is used to form the parts. Critical features of the mold insert and part are identified, and the mold insert is designed based on the injected part, which establishes the design and arrangement of conformal cooling channels, lines, or the like within the mold design, for example, a cooling channel 1400 shown in FIGS. 14A-14D. For example, a user can submit an initial three-dimensional computer-aided design (3D CAD) of a proposed part geometry or existing mold insert, depending on whether the mold insert being designed is a new tool to be constructed or retrofitted from an existing mold insert, where an existing mold can be modified to produce a new part. As described above, the part design drives the mold insert design. If one of the part design or the insert design is changed, then the other will change based on the forming process. The cooling channels, however, are only changed within the mold insert. Injection molded part features, such as thickness, flatness, etc. can affect the performance of cycle times and yields.

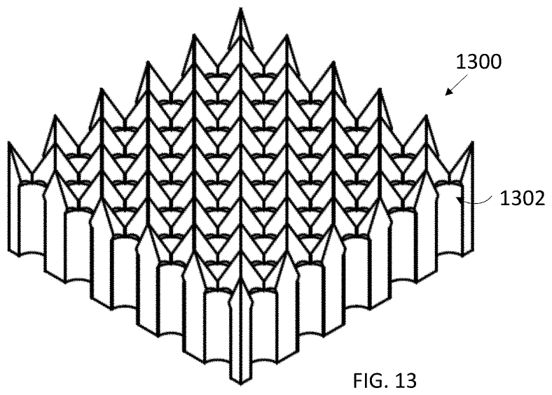

At least one heat transfer model complying with a proprietary predictive modeling algorithm may be applied to the received initial design. The predictive engineering model may reference a series of checks specific to part geometries in correspondence with manufacturing potential comparing conventional methods to additive manufacturing. In addition, the system and method can embed a temperature and pressure sensor 803 (see FIG. 8C) to generate performance-based pricing utilizing actual cooling times and a feedback loop to continually improve the modeling capabilities of the inventive system. The predictive engineering model(s) can be analyzed to determine which areas of the injection design are considered “hot spots,” or regions of an injection that are subject to larger thermal masses and extended cooling times. The initial design can therefore be redesigned to remove or mitigate the hot spots. For example, material can be removed from the hot spot regions as determined by the redesign. The cooling channels may then be incorporated into the new insert as determined by the location of the hot spots, for example, shown in FIGS. 14A-14D. In some embodiments, as shown in FIG. 13, lattice matrices 1300 are designed into the cooling channels 1302 to maximize heat transfer. After the design of the cooling channels, another predictive thermal model of the injection molding process can be developed that accounts for the design changes of the mold insert and associative molded part. The results of this subsequent model incorporate the effects of the conformal cooling channels into its algorithm.

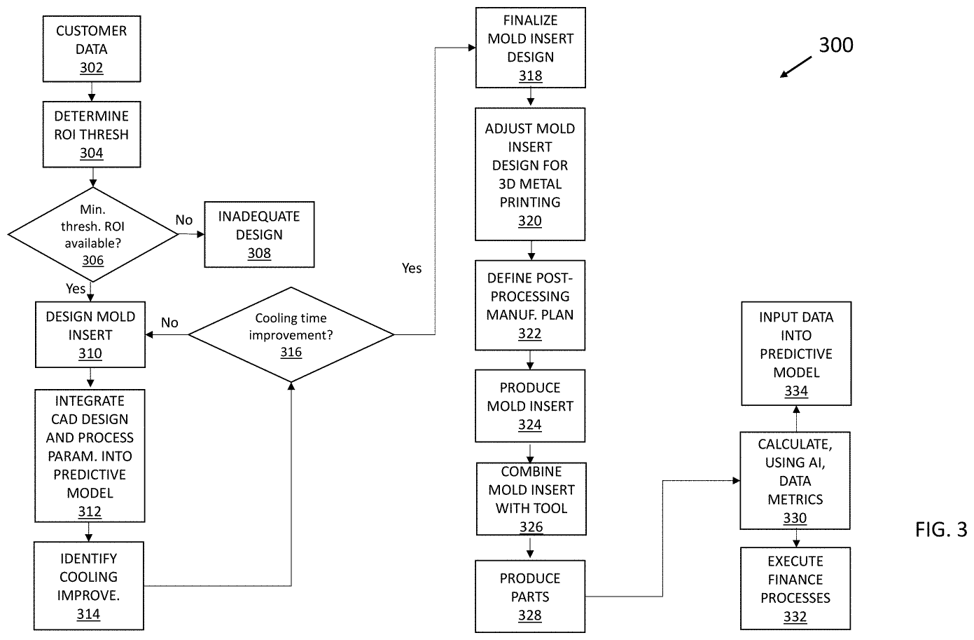

A special-purpose computer can store and execute the predictive learning model generated by an artificial intelligence computer system that contributes to or guides at least one of a design and construction of the conformally cooled three-dimensional (3D) metal printed mold insert. By improving the mold insert itself, this technology can be integrated directly into any injection mold tool for any injection molded part. This allows for industry standard injection molding processes to be performed. For example, when integrating the insert into an injection mold process, the current mold design and associative constraints of the injection mold machine and injection mold base are examined. This may include by way of example locations of the ejector pins, shutoffs for split-lines, threaded fastening locations, and other tight tolerance locations. Within these design constraints, the cooling lines are not placed within a predetermined distance, e.g., 1 mm, of any part geometry of the insert. By identifying and incorporating design constraints of the entire injection molding process at the onset of a project, an error-free integration is ensured. Here, the mold insert optimized according to embodiments of the present inventive concept relies on the same installation steps as the original mold insert. In some embodiments, a 3D metal printed mold insert produced by embodiments of a process, for example, described in FIGS. 3-7, can replace an existing milled mold insert as a “plug-and-play” mold insert. Here, the cooling process and derived performance integrates into existing cooling manifold setups. Cooling lines can be designed to be threaded with traditional assembly processes, but satisfy similar criteria as that described herein, e.g., not placed within a predetermined distance, e.g., 1 mm, of any part geometry of the insert. For example, a design may prohibit cooling channels on a slider of an insert, or other area on an injection mold tool used to create an undercut feature. Such moving parts can have an effect on a desirable location for providing cooling channels.

Surface finishing processes are often considered integral. The design process according to some embodiments takes the surface finish of the mold insert into consideration. Utilizing different texture processing techniques, the ideal texture and roughness of the mold surface can be accomplished as defined by the customer. This ensures that the quality of the finished parts produced by the mold produced by the insert meets or exceed customer specifications.

Accordingly, the inventive apparatus, system, and method solves a myriad of problems related to mold efficiency and quality for the entire manufacturing ecosystem of contract manufacturing and product innovators who use injection molding. For contract manufacturers, the inventive apparatus, system, and method creates additional capacity utilizing existing equipment thereby reducing future capex investment, thereby dramatically improving margins. For product innovators, the inventive apparatus, system, and method enables brands to be more competitive scaling faster at lower costs.

For the entire ecosystem, the inventive apparatus, system, and method improves the quality of an injection molded component involving an insert in many ways, such as: sink marks, flow lines, warping, distortion, and/or discoloration which eliminates the problem of high scrap rates, launch delays and the risk of product recalls. By creating conformal cooling channels that follow the unique geometry in the mold tool of an injection molded part, engineers can perfectly optimize their cooling lines resulting reduced cooling times and decreased potential for quality issues such as warping. These reduced cooling times lead to increased production throughput, allowing product innovators and manufacturers to produce more parts in less time.

The inventive apparatus, system, and method permits a user to create a new utility model for pricing molded parts as a transparent cost per second across all users. Based on the transparency and our proven cost savings a user can provide prices on a cost savings model like other utilities such as energy. For example, profitability can be attained because the inventive apparatus, system, and method can charge a percentage of the cost savings, for example, 25% but not limited thereto, associated with embodiments of the predictive and actual cooling time improvements by a turnkey solution for the entire production cycle. The presence of a proximity, temperature and pressure sensor of the mold insert can allow the creation of performance-based pricing utilizing actual cooling times and a feedback loop to ensure that the modeling capabilities continue to improve. In some embodiments, one or more sensors are installed in the mold insert for collecting temperature and pressure data at the interface between the mold insert and the injected polymer or metal part. In some embodiments, a sensor collects voltage signals which correlate to a temperature or pressure. This information can then be correlated to the data from the predictive engineering model to validate and improve it over time. Accordingly, the mold tool can rely on the sensor(s) to validate cooling improvements, for example, percentage values and ranges mentioned herein, and to identify discrepancies for analysis by the system.

Embodiments of an injection molding apparatus, system, and method including predictive modeling can drive cost savings and improves quality by accelerating molding cycle times, for example, 110% or greater, when compared with mold inserts produced with conventional gun drilling and other methods. This can reduce molded part costs, for example, by 25-75% or more.

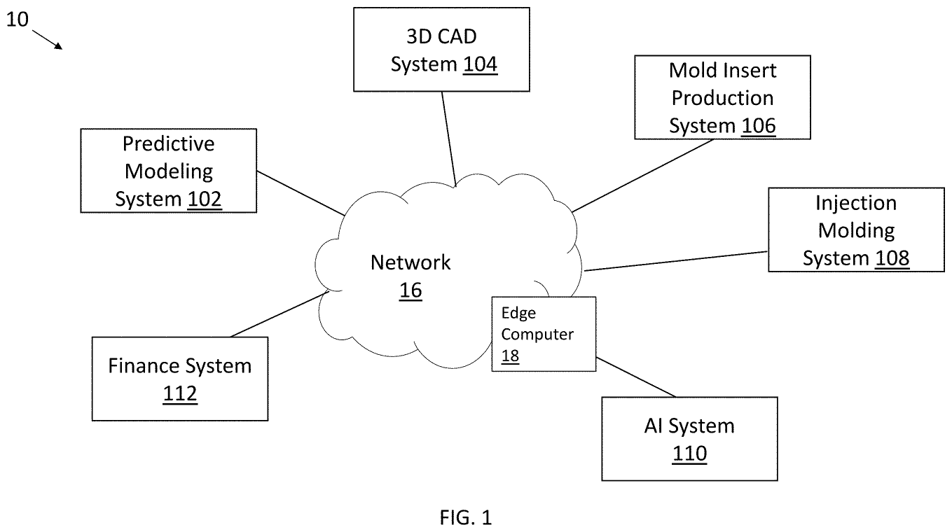

FIG. 1 is a block diagram of a system 10 for performing an injection molding operation at which embodiments of the present inventive concepts can be practiced. As shown in FIG. 1, in some embodiments, the system 10 can include but not be limited to some or all of a predictive modeling system 102, a three-dimensional computer-aided design (3D CAD) system 104, a mold insert production system 106, an injection molding system 108, an artificial intelligence (AI) system 110, and a finance system 112. The predictive modeling system 102, 3D CAD system 104, a mold insert production system 106, AI system, and finance system 112 can be part of one or more computers, i.e., having a processor, memory, I/O devices, and/or other hardware, software, or a combination thereof.

The predictive modeling system 102 executes an analysis according to one or more learning algorithms on an injection mold tool such as a 3D metal printed mold insert intended for forming a molded object or part. The generated analysis can include a predictive learning model or the like generated by the AI computer system 110 that contributes to or guides at least one of a design and construction of the mold insert. In some embodiments, the predictive modeling system 102 and AI computer system 110 are part of a same system, for example, executing processes on a common computer platform. In some embodiments, the AI computer system 110 is implemented in an edge computing device 18 or the like. For example, the AI computer system 110 can process received data to identify trends in a failing process, or process creep. This may alleviate risks such as pressure/temperatures that exceed predetermined or specified specifications which would otherwise yield poor cycle times and dimensionally unstable parts. The predictive modeling system 102 can be applied to design the metal insert with complex cooling channels, for example, channels constructed and arranged to include curved paths or other geometries allowing the channels to reach high-temperature areas. Conventional insert formation techniques rely on gun drilling to form cooling channels. However, these channels follow straight lines, which prohibit the channels to reach certain high temperature areas, and are incapable of following the unique geometry of the part. Here, the design and implementation of small-dimension contours, curves, and the like for routing around features of an insert being manufactured are not possible. Accordingly, features such as the cooling channel 1400 shown in FIGS. 14A-14D are not possible when formed by conventional insert formation techniques

In some embodiments, the predictive modeling system 102 can predict accelerated cycle times, undesirable high temperature regions of a mold and/or insert, or related characteristics.

The CAD system 104 permits users to generate designs in a computer environment for metal inserts and/or objects to be formed by an injection molding process. In some embodiments, the CAD system 104 communicates with the predictive modeling system 102 to generate a final 3D CAD design of a mold insert, e.g., a solid cast insert or the like, for use in the formation of an object by an injection mold apparatus. Predictive engineering modeling can be particularly applied to a CAD of an insert to include complex cooling channels, where Direct Metal Laser Sintering/Melting (DMLM/DMLS) or the like can be used to manufacture a steel mold insert including the pre-installed channels. The cooling channels can be designed as voided space by engineers to be perfectly optimized for the unique geometry of the molded part.

The mold insert production system 106 can produce mold inserts according to a combination of 3D CAD designs and predictive engineering modeling to manufacture the part with these channels already installed. The mold insert production system 106 can produce inserts with high precision that are adaptable to be used with standard molding equipment, for example, injection molding system 108, and vary in size and complexity.

The finance system 112 permits a performance-based billing model to be applied, for example, by generating a utility model for pricing molded parts as a transparent cost per second across all users, for example, when factors such as hourly rate are considered. This permits a manufacturer to provide a pricing model based on a cost savings model, similar to companies in the utility industry such as energy. For example, profitability can be attained because the finance system 112 can receive data from the mold insert production system 106 and/or injection molding system 108 and produce reports or the like that arrange the results so that a user can charge a percentage of the cost savings associated with the predictive and actual cooling time improvements by a turnkey solution for the entire production cycle. Cost savings can range at least 10% or more. For example, a determined original cooling time of a conventional cooling system can be provided as a benchmark or reference against an improved cooling time provided by an embodiment of a mold insert, for example, shown in FIGS. 8A-8C. A proximity switch or the like can measure the opening and closing of the tool, or more specifically a mold, to validate the cycle time for each individual part to determine the time savings.

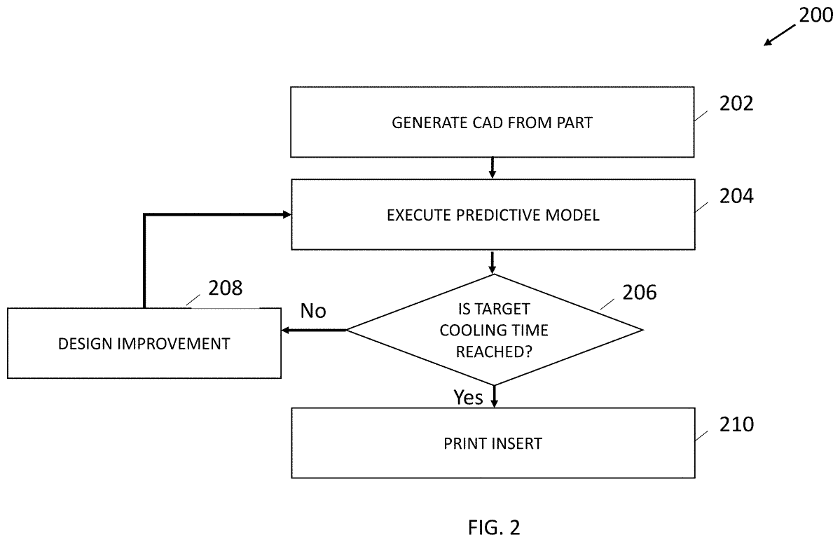

FIG. 2 is a method 200 for forming a mold insert for a part production process, in accordance with some embodiments. In some embodiments, the method 200 may include some or all elements of the system 10 of FIG. 1. The method 200 commences with the step 202 of preparing a model of the type of mold to be ultimately produced. This can be performed by generating a CAD or other electronic design from the part of interest. In some embodiments, CAD designs may be required for both the insert and the mold. In some embodiments, the mold insert is generated from and for the part of interest.

At step 204, a predictive engineering model is executed by a special-purpose computer and applied to the customer data produced in step 202. The predictive engineering model is generated based on the geometry of the injection mold insert and associated part being molded. Here, the customer-provided CAD model data can be integrated with project-specific process parameters or other information such as flow rates of the cooling liquid, part material (for specific heat and thermal conductivity), tool material (for specific heat and thermal conductivity), inlet and outlet locations of the injection mold tool. The predictive engineering model can identify potential improvements to the CAD design and generate a potential optimized CAD design. In doing so, the predictive engineering model can compare an original or previous CAD design to the generated optimized design and identify other possible improvements. The generated predictive engineering model can be analyzed, for example, by a human designer viewing predictive model data on a computer display and/or automatically, for example, by the AI system 110 to identify features of interest, such as features pertaining to the design of conformal cooling lines within the mold design. Examples of software-generated CAD features may include but not be limited to dynamic profiling, auto routing, and lattice structured cooling channels.

At decision diamond 206, the system 10 determines whether a target cooling time is reached. The target cooling time is predetermined, for example, established according to well-known factors such as part thickness, material qualities, heating temperature, and injection and holding time. The system can determine if the target time is reached by relying on the set target time by the manufacturer in order to reach throughout requirements. The predictive engineering model can analyze the system use and if the injecting of the material and cooling can attribute the right time to the overall cycle time. If a determination is made that the target cooling time is reached, then the method 200 proceeds to block 210, where the insert is produced, for example, formed by a 3D printer or other machine for machining or other otherwise forming the insert. Otherwise, the method proceeds to block 208 where design improvements, for example, described in embodiments herein, are implemented after which the predictive engineering model at block 204 is applied to the improved design.

In some embodiments, the machine monitoring feature leverages analog sensors, e.g., see FIG. 8C, which can be installed at the location of choice on the mold insert. A sensor can collect data to measure temperature as a function of time and/or pressure as a function of time. In some embodiments, the sensor can include a proximity switch to sense the opening and closing of a mold, in particular, for example, mold halves opening and closing. In benchmarking an acceptable temperature and pressure curve as a function of time, the learning model can be applied to find process deviations from the predictive engineering model. In addition, the process itself may deviate from the allowable limits. The data from the analog sensors is the analyzed and sent to a cloud computer or the like where it is processed in a digital format and extrapolated for key elements such as temperatures, pressures, cycle times. For example, machine monitoring can be performed by an electromechanical device that the executes an analog signal process, and outputs resulting data, for example, voltage values, to a cloud computer or other external computing environment. The data undergoes a process-specific analysis to determine a cycle time, whether the machine is actively being monitored, whether deviations within the process are taking place, and so on.

FIG. 3 is a flow diagram of a part production process 300 for an injection molding operation, in accordance with some embodiments. In describing the part production process 300, reference may be made to some or all elements of the system 10 of FIG. 1.

At block 302, a set of customer data is provided to the system 10 for processing. The customer data can include a Request for Quotation (RFQ) package of information provided by a contract manufacturer or product innovator that includes 3D CAD STEP data, 2D drawings, part material, cycle time targets, part quantities manufactured annually and for how many years.

At block 304, the customer data is input to a predictive modeling algorithm executed by a special-purpose computer 102 and/or the finance system 112, to determine if a minimum threshold return on investment (ROI) is available to provide a predetermined cooling time reduction, for example, a 50% reduction. The algorithm, for example, may include the following equation (Eq. 1):

original cooling time*machine rate−new cooling time*machine rate)*Number of parts=cost savings. Eq. 1:

In cases where a charge is provided to a customer for a system design, mold insert, and recurring revenue can be attained on the continued time savings and data analysis services offered by a provider. At decision diamond 306, a determination is made whether the minimum ROI threshold is available at the predetermined cooling time reduction. If no, then the process 300 proceeds to block 308, where the design is determined to be inadequate for cooling purposes with respect to the threshold ROI value. For example, the customer design may prohibit adequate cooling channels from being formed in the insert. If yes, then the process 300 proceeds to block 310, where the mold insert is designed with conformal cooling channels determined by the system to satisfy the predetermined minimum threshold return on investment (ROI). In some embodiments, prior to the step of designing the mold insert, a quotation for financial purposes may be generated for a customer or the like to determine whether it is acceptable to proceed from block 308 to block 310. For example, the equation above with respect to block 304 may be applied by the system to define a generated quotation value.

At block 312, the 3D CAD model designed in block 310 and project-specific process parameters are integrated into a predictive engineering model. Example process parameters may include but not be limited to thermal properties of the injected plastic or metal part such as thermal conductivity, density, heat capacity, viscosity, and so on.

At block 314, a cooling improvement is identified by comparing the original design and the optimized design. Here, details such as a boundary layer specific time of solidification can be identified. For example, the thermal gradients shown in FIGS. 11 and 12 illustrate how a solidification gradient is formed first from the outermost surface of a part. Also, quality related improvements can be identified through mechanical deformation modeling.

At decision diamond 316, a determination is made whether a threshold cooling metric is satisfied, for example, whether there is at least a 200% improvement in cooling. If no, then the method 300 returns to block 310 where the mold insert can be redesigned with conformal cooling channels determined by the system to satisfy the predetermined minimum threshold return on investment (ROI). If yes, then the method 300 proceeds to block 318 where the injection mold insert design is finalized, then to block 320 where the injection mold insert design, for example, plastic, is modified for 3D metal printing.

At block 322, a post-processing manufacturing design is defined from the 3D printed mold insert, also referred to as a 3D printed part distinguished from the injected part, to prepare the final injection mold insert.

At block 324, a mold insert is produced, for example a 3D metal print mold insert. An inspection step (not shown) may be performed between blocks 324 and 326.

Although not shown a post process can be performed on the 3D metal printed insert. Examples of post processing types may include but not be limited to CNC machining, wire cut, electric discharge machining (EDM), polishing, threading, sensor locations, and so on. In some embodiments, an inspection step (not shown) may be performed. For example, an IoT assembly step may be performed including an installation of the sensor in the injection mold apparatus and a temperature and/or pressure sensor directly into the mold insert.

At block 326, the formed metal insert is combined with the remainder of the plastic injection mold tool.

At block 328, at least one plastic injection molded part is produced. Between steps 326 and 328 may include a step where a trial insert mold is produced (not shown) to confirm the actual cooling time.

At block 330, a set of data metrics are calculated for the produced plastic injection molded parts in block 328. In some embodiments, the AI computer system 110 generates data for contribution to the data metric calculations. Data metrics may include but not be limited to the number of cycles, temperature and/or pressure as a function of time, predictive metrics for preventive maintenance such as the cleaning of cooling lines due to poor flow, and so on.

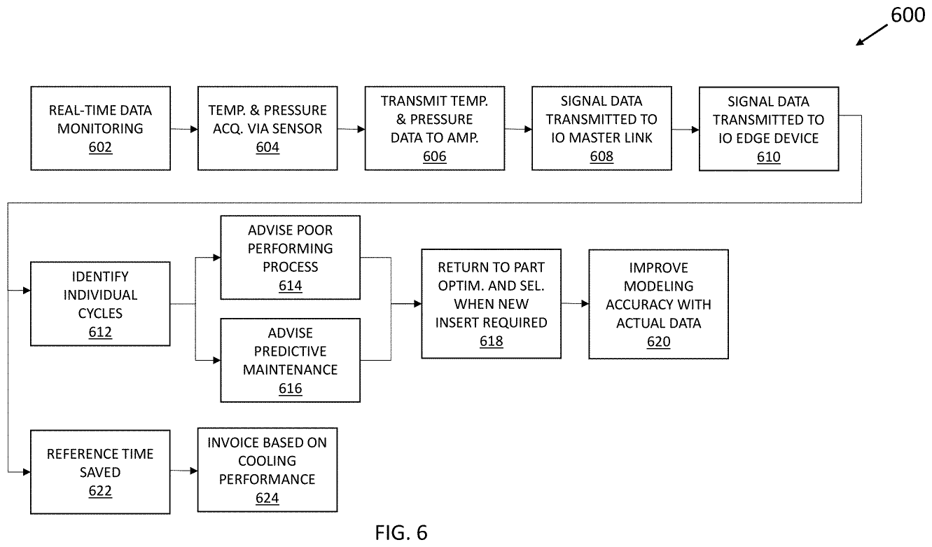

At block 332, one or more finance processes are executed. In some embodiments, a finance process is part of an off-the-shelf or proprietary accounting system that produces billing invoices or the like according to a performance-based revenue model, for example, described with reference to FIG. 6. Block 332 may result from AI calculations or provide a connection between a predictive engineering model according to embodiments herein, either with or without a mold insert defined by the equation above described in block 304.

At block 334, the data generated and output from the data metrics in block 330 is input into the predictive engineering model to provide continuous improvement data for the process 300.

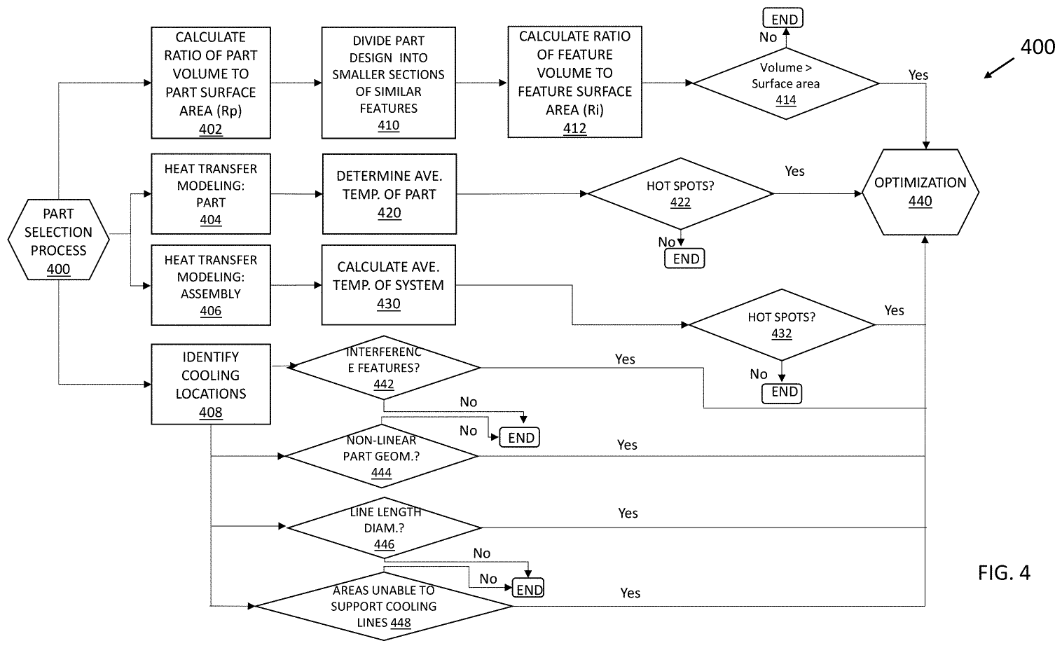

FIG. 4 is a flow diagram of a part selection process 400, in accordance with some embodiments. In describing the part selection process 400, reference may be made to some or all elements of the system 10 of FIG. 1. The part selection process 400 may be executed to identify a potential for a particular part for improvement or identify features of a part that can be redesigned, or to determine approaches for cooling a part formed by injection molding in an efficient and optimized manner.

The part selection process 400 can be applied to identify parts that are candidates for improvement or redesign with respect to cooling optimization. At block 402, a ratio of a part volume and a part surface area is determined by a special-purpose computer processor of the system. The ratio may be calculated for a part of interest. More specifically, the volume and surface area can be provided as inputs from a CAD or electronic design of the part of interest, or determined from a physical object, for example, an object to be retrofitted or otherwise modified. After the ratio calculation at block 402 is performed, the process 400 proceeds to block 410, where the part design is divided into smaller sections having similar features. Block 410 can be performed to perform a finite element analysis with respect to heat transfer. At block 412, where a ratio of a sub-part or feature volume and a sub-part or feature surface area is calculated by a special-purpose computer processor of the system. Similar calculations can be performed on each sub-part or feature of the subdivided part design in block 410. At decision diamond 414, the system determines whether the pieces and/or sub pieces of the part have a volume that is greater than surface area. For example, a volume may be 1.1 times larger than the surface area which can subject the part to overheating. The system can identify such areas and address overheating risks by part redesign and cooling optimization techniques described in embodiments herein.

The part selection process 400 may, in parallel or otherwise independently of block 402, proceed to block 404 where a heat transfer modeling process is performed on a part of interest, which is part of an individual item of interest. A heat transfer model can comply with a predictive modeling algorithm and be applied to a received design.

After the heat transfer modeling process at block 404 is performed on the particular part of interest, the process 400 proceeds to block 420, where the average temperature of the part is determined by measuring the maximum and minimum temperature of the part as a function of time, which may serve as an indicator of a cooling time for subsequent determinations.

At decision diamond 422, a determination is made whether one or more hot spots are identified in the part under design from the results generated in block 420. If yes, then the method proceeds to block 440 where an optimization process is performed. Here, the part feature is updated to minimize thickness in this location and allow for more uniformity of cooling. If no, then the part selection process 400 is completed.

The part selection process 400 may, independently of blocks 402 and 404, proceed to block 406 where a heat transfer modeling process is performed on the system, including the part, the mold insert, and the injection molding apparatus. In some embodiment embodiments, the assembly has existing cooling channels.

After the heat transfer modeling process at block 406 is performed on the part, the process 400 proceeds to block 430, which may be similar to block 420 except that the average temperature of the part is different depending on referencing the heat transfer as a standalone part, or the assembly apparatus as a whole.

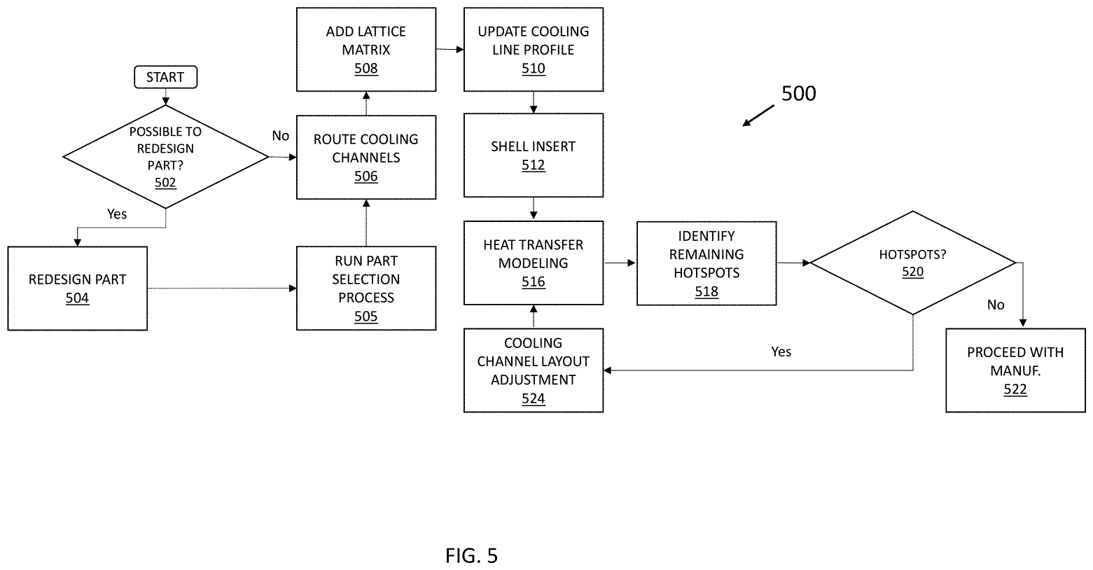

At decision diamond 432, a determination is made whether one or more hot spots are identified in the part under design from the results generated in block 430. If yes, then the method proceeds to block 440 where an optimization process is performed. Here, the injection molded part features may be updated, and the cooling channel design will be altered to ensure a better overall performance. This may pertain to features described in FIG. 5 with respect to optimization. If no, then the part selection process 400 is completed.

At block 408, one or more cooling locations are identified that cannot be produced by subtractive manufacturing, for example, removing material by machine such as cutting, boring, drilling, grinding, and so on. However, the cooling locations can be produced by additive manufacturing or 3D printing processes, for example, by adding material one layer at a time. The process 400 proceeds from block 408 to four different decision diamonds. At decision diamond 442, the system 10 when identifying cooling locations determines whether interference features are present, for example, critical molded part features that would be machined away when configuring the part to receive the cooling lines at the identified cooling locations. If yes, then the process 400 proceeds to block 440 where an optimization process is performed. If no, then the part selection process 400 is completed.

At decision diamond 444, the system 10 when identifying cooling locations determines whether non-linear part geometries are present. If yes, then the process 400 proceeds to block 440 where an optimization process is performed. If no, then the part selection process 400 is completed.

At decision diamond 446, the system 10 when identifying cooling locations determines whether the cooling line lengths with diameter are greater than a predetermined ratio, for example, a length ratio greater than 1:10. The ratio is relevant because excessively long cooling lines are subject to loss of part:tool surface area cooling. Also, the time and cost for the long cooling lines provides an opportunity for a user to identify an opportunity to use the system to switch to a conformal cooling configuration. If yes, then the process 400 proceeds to block 440 where an optimization process is performed. If no, then the part selection process 400 is completed.

At decision diamond 448, the system 10 when identifying cooling locations determines whether areas are present which cannot support cooling lines with a circular shape, for example, as referenced by a cross-section normal to the circle's center. Traditional cooling methods have a circular profile. The geometry of an injection part may cause a cylindrical cooling line to be unapproachable or infeasible in certain locations. In this way, non-circular and non-linear cooling channels are better suited for additive manufacturing. If yes, then the process 400 proceeds to block 440 where an optimization process is performed. If no, then the part selection process 400 is completed. Referring again to the optimization step 440, here the part design is modified, optimized, and so on. In some embodiments, the surface area relates to the exposed surface area of the injection molded part in addition to the surface area of the cooling lines in the mold insert as compared to the surface area of the injection molded part. The metal printed mold inserts formed according to embodiments herein allow for a ratio of surface area to surface area to be at or near a 1:1 ratio.

FIG. 5 is a flow diagram of a part redesign and optimization process 500, in accordance with some embodiments. In describing the part redesign and optimization process 500, reference may be made to some or all elements of the system 10 of FIG. 1.

At decision diamond 502, a determination is made whether it is possible to redesign a particular part. If yes, then the process 500 proceeds to block 504, where the part design is updated or modified to maintain an intention of the design while yielding desirable manufacturing results. The part may be redesigned, for example, by removing as much material volume from predetermined hot spots as mechanically possible and according to the generated design. The process 500 then proceeds to block 505, where a part selection process is executed, for example, some or all of the part selection process 400 of FIG. 4. At block 506, cooling channels are arranged to be routed to be at least at a predetermined distance from the hot spots identified in the part selection step 505, for example, in close proximity, e.g., 0.1-0.5 mm, to the hot spots.

Returning to decision diamond 502, if a determination is made that it is not possible to redesign the particular part, then the process 500 proceeds directly to block 506, where the cooling channels are routed in close proximity to the hot spots.

At block 508, a lattice matrix, e.g., 1300 shown in FIG. 13, is designed into the cooling channels 1302 to maximize heat transfer. The lattice structure can function as a heat sink and be provided by 3D printing or the like. The cooling channels can be auto generated to add value flexibility from part to part.

At block 510, a cooling line profile is updated. As described in block 508, the cooling channels can be auto generated. Here, a spline can be included with an auto-changing profile to ensure maximum cooling and manufacturability of the part being formed.

At block 512, a shell insert is provided to remove excess material with a predetermined thickness, for example, 1 mm, and required supports to accommodate 3D printing or the like. The shell insert creates space within the mold insert, i.e., provides pockets of air, which provides insulation and force the cooling in specific directions.

At block 516, a heat transfer modeling process is performed by the system for injection molding. For example, heat transfer modeling for injection molding can begin at t=0, i.e., where plastic injection occurs at a temperature that permits the injection molding to occur.

At block 518, remaining hot spots are identified. This can be achieved by an equation that compares temperatures of regions of the part with an average temperature of the whole part. For example, if the temperature of an identified region is a predetermined value, e.g., 105%, greater than the average temperature, a hot spot is identified at the region, which can be identified, for example, displayed on a computer display. If at decision diamond 520 there are no identified hot spots, then the method 500 proceeds to block 522, where the part(s) are manufactured. Otherwise, the method 500 proceeds to block 524, where cooling channel adjustments are performed, for example, described in embodiments herein where the 3D metal printed plastic injection mold insert is designed, manufactured, and installed according to a predictive modeling process.

FIG. 6 is a flow diagram of a business process 600, in accordance with some embodiments. In describing the business process 600, reference may be made to some or all elements of the system 10 of FIG. 1.

At block 602, a real-time monitoring process is performed. This may be achieved at block 604, where temperature and pressure data are acquired from one or more sensors 803, for example, shown in FIG. 8C.

At block 606, the temperature and pressure data are transmitted to an amplifier or other apparatus that converts analog signals to digital data for processing by the computer-centric elements of the system 10.

At block 608, signal data is sent to an I/O master link, which may include the amplifier or other analog-to-digital converter of block 606, and at block 610 output to an edge computer 18, which may include or otherwise communicate with an AI system.

At block 612, individual cycles are identified by an analysis of data corresponding to the received cycle time and pressure data. For example, a cycle may include high temperatures and/or pressures that transition to low temperatures and/or pressures. This transition data can be generated as curves that depict this transition and may be used to identify cycle times for analysis.

At block 614, a determination is made that the analysis performed at block 612 establishes a poor performance process. In some embodiments, the poor performance process is based on the pressure or temperature fluctuating 5% or more from a nominal pressure of temperature.

At block 616, a determination is made that the analysis performed at block 612 establishes that predictive maintenance is required, for example, information on when to clean out water lines, when a new insert is needed, etc. For example, pressure drops may be determined by the system 10 due to bad fittings or other purposes. In another example, a determination may be made that the part of interest requires additional time to cool and that the corresponding cycle times increase due to the required additional cooling time.

The process 600 may proceed from block 614 and/or block 616 to block 618, where the process 600 returns to the part selection process of FIG. 4 and/or part optimization process of FIG. 5 when a new 3D metal printed mold insert is required, for example, based on a determination of an end of life of the printed mold insert. An end of life may be due to the general wear and tear of the tool, actual material removing and then causing issues such as flash, dimensions that deviate too far from nominal.

At block 620, a machine learning algorithm executed by the AI system 110 generates data to improve modeling accuracy.

As described above, the sensors and machine monitoring are performed to collect information regarding the mold part formed by the newly designed insert integrated into the mold tool. In doing so, the process may proceed to block 622 in addition to block 612. At block 622, reference on a per part basis made with respect to the time saved due to cooling performance. The time saved can be calculated by subtracting the optimized cooling time from the original cooling time, for example, described in embodiments herein.

At block 624, an invoice based on cooling performance can be generated. In some embodiments, the invoice can include a cost that equals a sum of the time saved multiplied by the rate for each part.

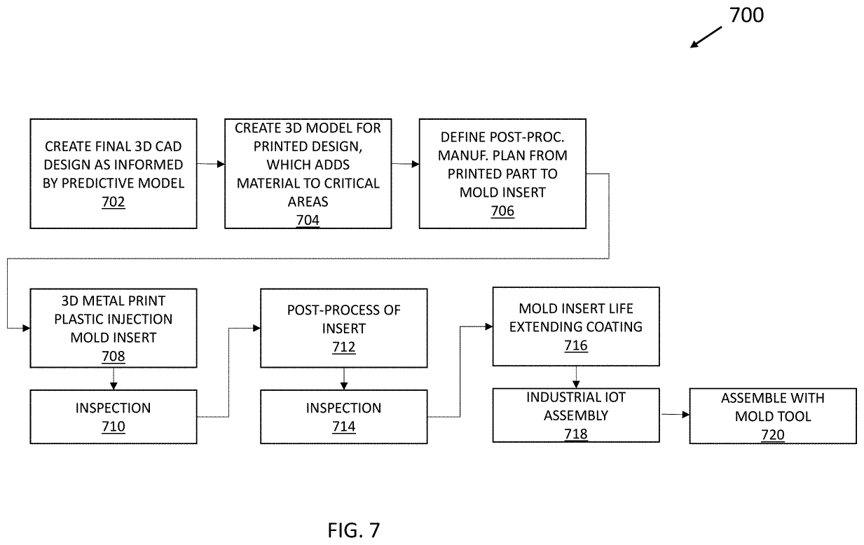

FIG. 7 is a flow diagram of a manufacturing process 700, in accordance with some embodiments. In describing the manufacturing process 700, reference may be made to some or all elements of the system 10 of FIG. 1.

At block 702, a final CAD design is generated as informed by the predictive engineering model to use in the plastic injection mold tool. For example, a 3D CAD design can be generated according to a predictive engineering model described herein for use in metal 3D printing. The CAD design includes cooling flow geometries and directions for heat dissipation from hotspots, and which can be used in a tooling or manufacturing operation.

Accordingly, at block 704, a 3D model of an insert is generated from the design. A 3D printer or the like may be used to produce the 3D model. In some embodiments, the 3D model adds material of at least 0.01 mm to critical areas at or proximal to ejector pin locations, threaded hole locations, polished surfaces, and/or other surfaces requiring precision mating to contribute to reduce, improve, or optimize the mold insert with respect to cooling during manufacturing.

At block 706, a post-processing manufacturing plan is defined from the mold insert to form a final plastic injection mold insert. Details such as CNC machining, wire cut, electric discharge machining (EDM), threading, sensor locations, and so on can be included in the post-processing manufacturing plan.

At block 708, a 3D metal printed insert for a plastic injection mold is formed. At block 710, the 3D metal printed insert is inspected, for example, through a coordinate measuring machine (CMM) and hand calipers. At block 712, a post process of the 3D metal printed insert is performed (distinguished from the post process of the part of interest described in block 706). At block 714, another inspection is performed.

At block 716, a mold insert life extending coating is provided. The coating may be provided by a third-party provider, for example, illustrated in the following hyperlink: https://alcadyne.com/6-point-injection-mold/incorporated by reference herein in its entirety. At block 718, an industrial Internet-of-Things (IIOT) monitoring device, for example, described herein, is provided. At block 720, The insert can be assembled for coupling or otherwise integrating with a plastic injection mold tool and produced for use in production.

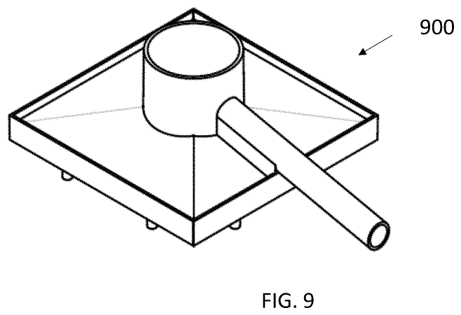

FIGS. 8A-8D illustrate an example of a mold insert 800 produced according to one or more processes of FIGS. 2-7. For example, the holes 804 in the mold insert 800 may be formed by machining, drilling, grinding, and the like according to a predictive modeling process described in FIGS. 2-7. In particular, the system 10 shown in FIG. 1 may use the mold insert 800 to produce the part 900 shown in FIG. 9. In another example shown in FIG. 11, a mold insert 1104 is used to produce a part 1102.

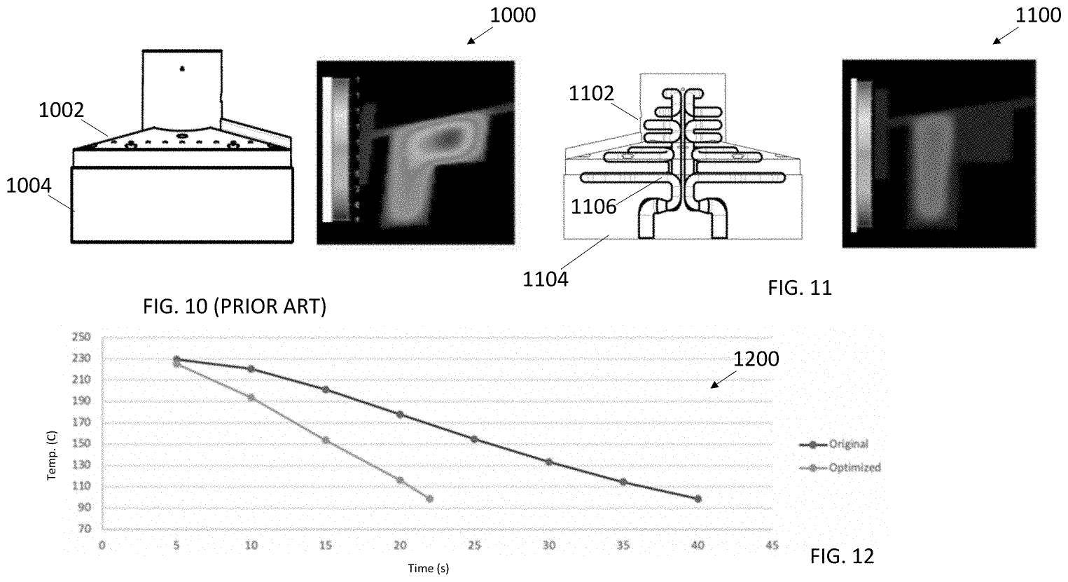

The construction of the mold insert 800 includes modified design features and to accelerate cooling cycle times determined by the prediction model. In this example, throughout or injection molding times can be improved by 200-400%, and cooling cycle times can be reduced due to the modified design, for example, shown in the graph 1200 of FIG. 12, which may correspond to FIGS. 10 and 11, respectively. Referring again to FIG. 11, the arrangement of cooling lines 1106 of the insert 1104 permits for heat dissipation from hotspots at 20 seconds detected on a part 1102 formed by the insert, shown by comparison to the part 1002 and insert 1004 in FIG. 10. In particular, the hotspots 1000, 1100 shown in FIGS. 10 and 11, respectively are emulated in response to a predictive engineering technique that can be performed in accordance with embodiments herein, and more specifically, the hotspots are digital representations of physical parts. In another example, the design changes and remolding of the part 900 shown in FIG. 9 or part 1102 shown in FIG. 11 is due to the elimination of materials during mold insert manufacturing that cause excessive heating times resulting in sink marks or the like. However, as compared to the original design, the height, width, and other dimensions can be maintained to ensure the original intended functionality.

Referring again to FIGS. 14A-14D, provided are views of a dynamic cooling channel 1400, in accordance with some embodiments. The cooling channel 1400 is identified as dynamic because the profile of the cooling channel 1400 changes with regard to the angle of the profile shape compared to the print plane. The channel 1400 can be printed supportless regardless of the angle. Each printer has process capabilities, and typically a shape printed at 45 degrees or more would collapse on itself. The dynamic channel 1400 overcomes this issue.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of forming a mold insert for an injection molding operation, comprising:
providing a design of an injection mold part;
analyzing, by a predictive model, the design to determine a conformal cooling arrangement for a mold insert for forming the injection mold part; and
forming the mold insert including the conformal cooling arrangement.

2. The method of claim 1, further comprising: embedding a sensor in the injection mold insert for providing a feedback loop that modifies a result of the predictive model.

3. The method of claim 2, wherein the sensor at least one of measures temperature as a function of time, measures pressure as a function of time, and identifies an opening and closing of a mold.

4. The method of claim 1, wherein analyzing, by the predictive model, the design includes:
integrating CAD model data of a first CAD design of the design with a set of project-specific process parameters or other information;
identifying, by the predictive model, potential improvements to the first CAD design to generate a second CAD design; and
comparing, by the predictive model, the first CAD design and the second CAD design to identify possible improvements to the second CAD design.

5. The method of claim 4, wherein the predictive model is analyzed by an artificial intelligence system to identify features pertaining to a design of conformal cooling lines of the conformal cooling arrangement within the mold insert.

6. The method of claim 1, further comprising: modifying the design so that the cooling flow geometry and direction from heat dissipation from hotspots detected in the part is changed to reduce or eliminate the hotspots.

7. The method of claim 6, wherein the hotspots are digital representations of the injection mold part, and are emulated in response to the step of analyzing, by a predictive model, the design.

8. The method of claim 1, further comprising forming at least one lattice matrix into cooling channels of the conformal cooling arrangement.

9. The method of claim 1, further comprising:
executing an artificial intelligence process to calculate data metrics in response to forming the injection mold part from the produced mold insert; and
inputting the data metrics to the predictive model.

10. The method of claim 1, further comprising:
performing a part selection process including determining a part volume to surface area ratio; and
modifying the design of the injection mold part in response to the part volume to surface area ratio exceeding a predetermined threshold.

11. The method of claim 1, further comprising:
performing a machine operation on the mold insert;
collecting data on time savings estimates due to the conformal cooling arrangement; and
generating a financial invoice from the collected data.

12. The method of claim 1, further comprising:
generating post-processing manufacturing plan from the mold insert to form a final plastic injection mold insert

13. A method for molding a part of interest, comprising:
providing a design of an injection mold part;
analyzing, by a predictive model, the design to determine a conformal cooling arrangement for a mold insert for forming the injection mold part;
forming the mold insert including the conformal cooling arrangement; and
forming the injection mold part by heating a source of material at the mold insert and cooling the source of material by the conformal cooling arrangement.

14. The method of claim 13, further comprising: embedding a sensor in the injection mold insert for providing a feedback loop that modifies a result of the predictive model.

15. The method of claim 13, wherein analyzing, by the predictive model, the design includes:
integrating CAD model data of a first CAD design of the design with a set of project-specific process parameters or other information;
identifying, by the predictive model, potential improvements to the first CAD design to generate a second CAD design;
comparing, by the predictive model, the first CAD design and the second CAD design to identify possible improvements to the second CAD design.

16. The method of claim 15, wherein the predictive model is analyzed by an artificial intelligence system to identify features pertaining to a design of conformal cooling lines of the conformal cooling arrangement within the mold insert.

17. The method of claim 13, further comprising: modifying the design so that the cooling flow geometry and direction from heat dissipation from hotspots detected in the part is changed to reduce or eliminate the hotspots.

18. The method of claim 13, further comprising forming at least one lattice matrix into cooling channels of the conformal cooling arrangement.

19. The method of claim 1, further comprising:
performing a part selection process including determining a part volume to surface area ratio; and
modifying the design of the injection mold part in response to the part volume to surface area ratio exceeding a predetermined threshold.

20. A part formed according to the process comprising steps of:
providing a design of an injection mold part;
analyzing, by a predictive model, the design to determine a conformal cooling arrangement for a mold insert for forming the injection mold part;
forming the mold insert including the conformal cooling arrangement; and
forming the injection mold part by heating a source of material at the mold insert and cooling the source of material by the conformal cooling arrangement.
